(19) United States
(12) Patent Application Publication
(10) Pub. No.: US 2009/0051668 A1
(43) Pub. Date: Feb. 26, 2009

(54) Touch Panel Structure

(76) Inventor: Po-Ping CHENG, His-Chih City (TW)

Correspondence Address: TROXELL LAW OFFICE PLLC, Suite 1404, 5205 Leesburg Pike, Falls Church, VA, 22041, US

(21) Appl. No.: 12/197,675

(22) Filed: Aug. 25, 2008

(30) Foreign Application Priority Data
Aug. 24, 2007 (TW) 096131410

(51) Int. Cl. G06F 3/041

(52) U.S. Cl. 345/173

(57) ABSTRACT

The present invention discloses a touch panel structure comprising: a transparent substrate to carry the components described later; a first conductive layer formed on one side of the transparent substrate and having a plurality of first sensing bands each of which is disposed with at least a first sensing zone and is disposed with a conductive wire on its end to connect with a first electrode layer; an insulated dielectric layer formed on the first conductive layer; and a second conductive layer coated on the insulated dielectric layer and having a plurality of second sensing bands each of which is disposed with at least a second sensing zone and is disposed with a conductive wire on its end to connect with a second electrode layer.

### FIELD OF THE INVENTION

The present invention relates to a touch panel structure, and more particularly to a touch panel structure which is a transparent substrate coated with a first conductive layer, an insulated dielectric layer, and a second conductive layer to increase light transmittance and reduce production cost.

### BACKGROUND OF THE INVENTION

Touch panel has been used for many years and its structure is largely based on a glass substrate/glass substrate (G/G) or glass substrate/film (G/F). The glass substrate/glass substrate (G/G) touch panel with two layers of glass has the following drawbacks: higher cost, harder pushing required due to large spacing between conductive layers, and lower light transmittance. The glass substrate/film (G/F) touch panel, on the other hand, has the following shortcomings: film unable to withstand high temperature and thus unsuitable for car use and low light transmittance.

Consequently, it is necessary to design a new touch panel structure to overcome the drawbacks described above.

### SUMMARY OF THE INVENTION

The primary objective of the present invention is to provide a touch panel structure, wherein the transparent substrate is coated with a first conductive layer, an insulated dielectric layer, and a second conductive layer to enhance its light transmittance.

Another objective of the present invention is to provide a touch panel structure, wherein the transparent substrate is coated with a first conductive layer, an insulated dielectric layer, and a second conductive layer to reduce production cost.

A further objective of the present invention is to provide a touch panel structure, wherein the spacing between the first conductive layer and the second conductive layer is reduced to enhance its touch sensitivity.

To accomplish the objects described above, a touch panel structure according to the present invention comprises: a transparent substrate to carry the components described later; a first conductive layer formed on one side of the transparent substrate and having a plurality of first sensing bands each of which is disposed with at least a first sensing zone and is disposed with a conductive wire on its end to connect with a first electrode layer; an insulated dielectric layer formed on the first conductive layer; and a second conductive layer coated on the insulated dielectric layer and having a plurality of second sensing bands each of which is disposed with at least a second sensing zone and is disposed with a conductive wire on its end to connect with a second electrode layer.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 schematically illustrates the structure of a touch panel structure according to a preferred embodiment of the present invention;

FIG. 2 schematically illustrates the other side of a touch panel structure of the present invention further disposed with an anti-scratch layer;

FIG. 3 schematically illustrates a plurality of first sensing bands formed by etching or coating the first conductive layer of the present invention;

FIG. 4 schematically illustrates the first electrode layer printed on the transparent substrate of the present invention;

FIG. 5 schematically illustrates a plurality of second sensing bands formed by etching or coating the second conductive layer of the present invention; and

FIG. 6 schematically illustrates the second electrode layer printed on the transparent substrate of the present invention.

### DETAILED DESCRIPTION OF THE PREFERRED EMBODIMENTS

The structure, technical measures and effects of the present invention will now be described in more detail hereinafter with reference to the accompanying drawings that show various embodiments of the invention.

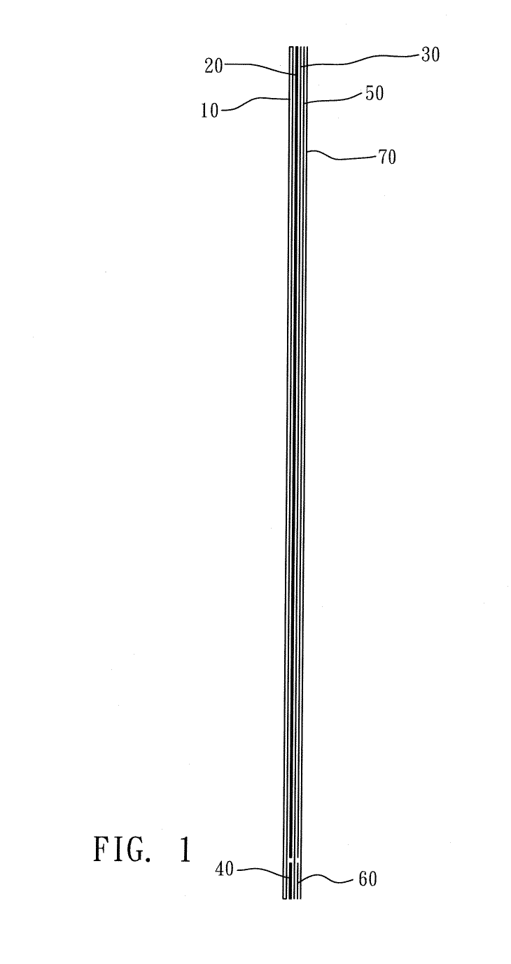

With reference to FIGS. 1 to 6, the touch panel of the present invention comprises at least, a transparent substrate 10; a first conductive layer 20; an insulated dielectric layer 30, and a second conductive layer 50, wherein the transparent substrate 10; made of, for example but not limited to, glass, polycarbonate (PC), poly-methyl meth-acrylic (PMMA), polyethylene terephthalate (PET), or cellulose triacetate (TCA); is to carry the first conductive layer 20, the insulated dielectric layer 30, and the second conductive layer 50. In the present embodiment, the transparent substrate 10 is, but not limited to, a glass substrate for explanation purpose.

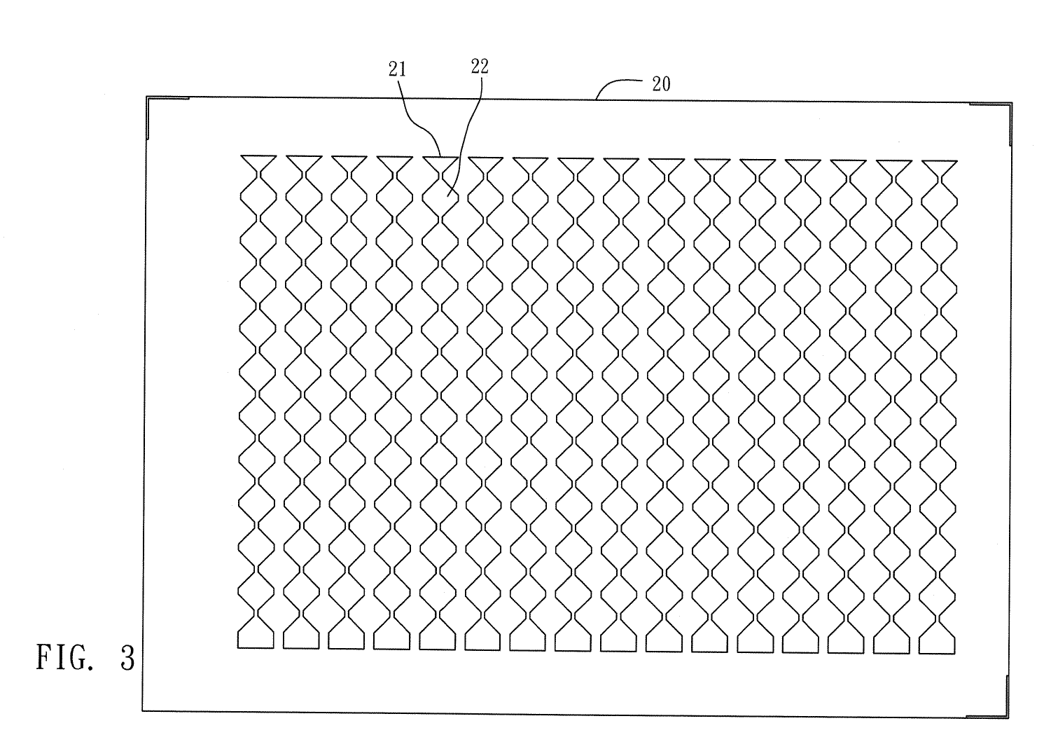

The first conductive layer 20 is formed, for example but not limited to, by coating indium tin oxide (ITO) or antimony-doped tin oxide (ATO), on one side, for example but not limited to its top, of the transparent substrate 10. The first conductive layer 20 has a plurality of first sensing bands 21 each of which is disposed with at least a first sensing zone 22 and is disposed with a conductive wire 41 on its end to connect with a first electrode layer 40. The first sensing bands 21 are formed by, for example but not limited to, etching on the first conductive layer 20 and arranged, for example but not limited to, in parallel longitudinally. Also, the first sensing bands 21 may sense the pushing action along, for example but not limited to, the X-direction and the first sensing zone 22 of the sensing band 21 is, for example but not limited to, rhombic, bar-like, triangular, hexagonal, or circular in shape. The present embodiment adopts, for example but not limited to, the hexagonal shape for explanation purpose. The number of the first sensing band 21 and the first sensing zone 22 can be adjusted depending on actual demand; increasing their numbers can enhance the sensibility, yet the cost is heightened at the same time. FIG. 3 schematically shows the first sensing bands 21 and the first sensing zones 22 formed by etching or coating the first conductive layer 20, wherein the first sensing bands 21 are arranged in parallel longitudinally.

The insulated dielectric layer 30 is formed by coating insulated material on the first conductive layer 20, wherein the insulated material is a composite of, for example but not limited to, silicon dioxide (SiO₂), tin dioxide (TiO₂), or titanium dioxide (TiO₂).

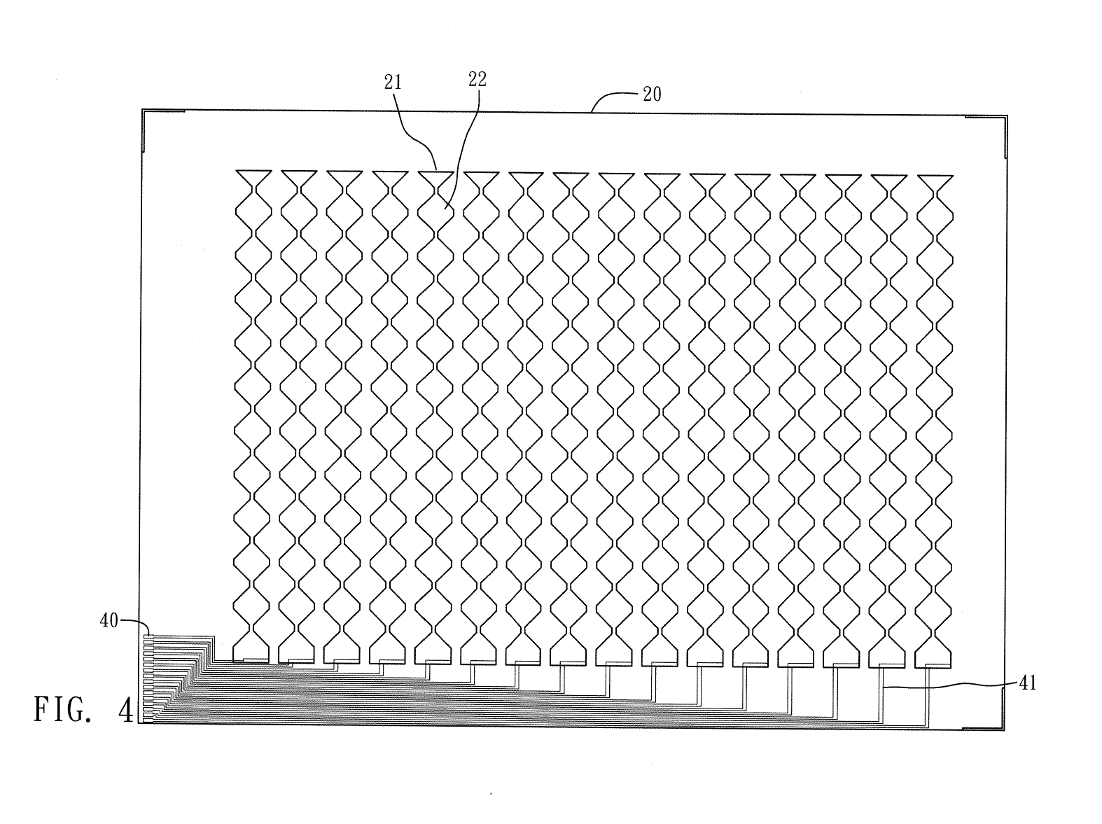

With reference FIG. 4, the first sensing bands 21 and the first sensing zones 22 of FIG. 3 are printed with the first electrode layer 40 and a plurality of conductive wires 41 such that the first sensing bands 21 can be coupled with the first electrode layer 40 through the conductive wires 41 and in turn connected with external control circuits (not shown). The first conductive layer 40 is formed, for example but not limited to, by printing conductive material such as silver paste, carbon paste, or copper paste onto the transparent substrate 10, and the number of the conductive wires 41 is not necessary to be identical to that of the first sensing bands 21. Also, the first electrode layer 40 is disposed on, for example but not limited to, the lower end of the transparent substrate 10.

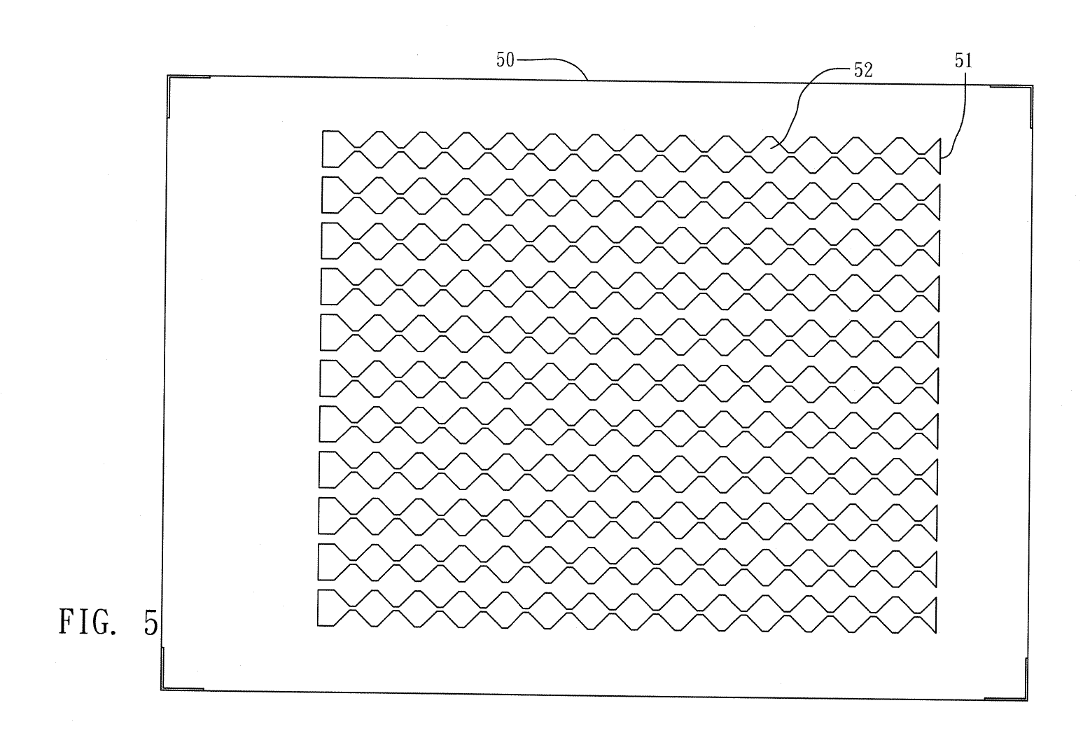

The second conductive layer 50 is formed, for example but not limited to, by coating indium tin oxide (ITO) or antimony-doped tin oxide (ATO), on the insulated dielectric layer 30. The second conductive layer 50 has a plurality of second sensing bands 51 on each of which is disposed with at least a second sensing zone 52 and is disposed with a conductive wire 61 on its end to connect with a second electrode layer 60. The second sensing bands 51 are formed, for example but not limited to, by coating on or etching the second conductive layer 50 and arranged, for example but not limited to, in parallel transversally. Also, the second sensing bands 51 may sense the pushing action along, for example but not limited to, the Y-direction and the second sensing zone 52 of the sensing band 51 is, for example but not limited to, rhombic, bar-like, triangular, hexagonal, or circular in shape. The present embodiment adopts, for example but not limited to, the hexagonal shape for explanation purpose. The number of the second sensing band 51 and the second sensing zone 52 can be adjusted according to actual demand; increasing their numbers can enhance the sensibility, yet the cost is heightened at the same time. FIG. 5 schematically shows the second sensing bands 51 and the second sensing zones 52 formed by etching or coating the second conductive layer 50, wherein the second sensing bands 51 are arranged in parallel transversally. In addition, the first sensing bands 21 and the second sensing bands 51 are arranged in an orthogonal manner

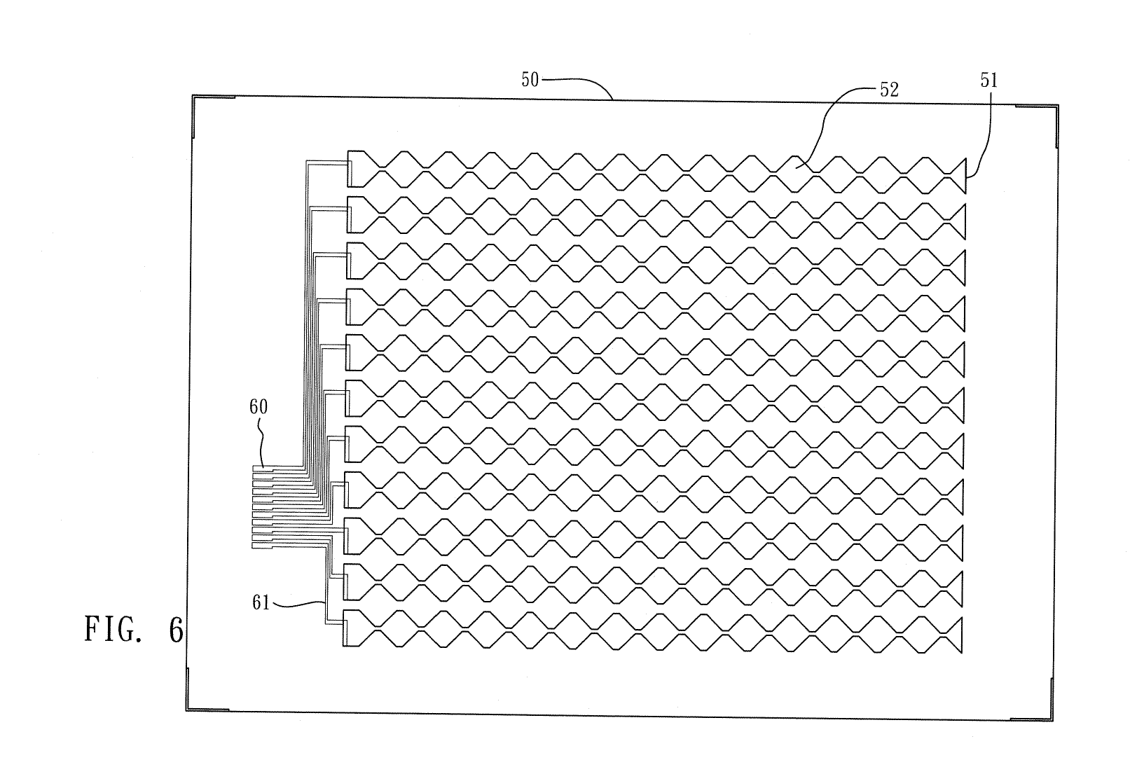

With reference FIG. 6, the second sensing bands 51 and the second sensing zones 52 of FIG. 5 are printed with the second electrode layer 60 and a plurality of conductive wires 61 such that the second sensing bands 51 can be coupled with the second electrode layer 60 through the conductive wires 61 and in turn connected with external control circuits (not shown). The second conductive layer 60 is formed, for example but not limited to, by printing conductive material such as silver paste, carbon paste, or copper paste onto the transparent substrate 10, and the number of the conductive wires 61 is not necessary to be identical to that of the second sensing bands 51. Also, the second electrode layer 60 is disposed on, for example but not limited to, the left side of the transparent substrate 10, but the second electrode layer 60 cannot be overlapped with the first electrode layer 40.

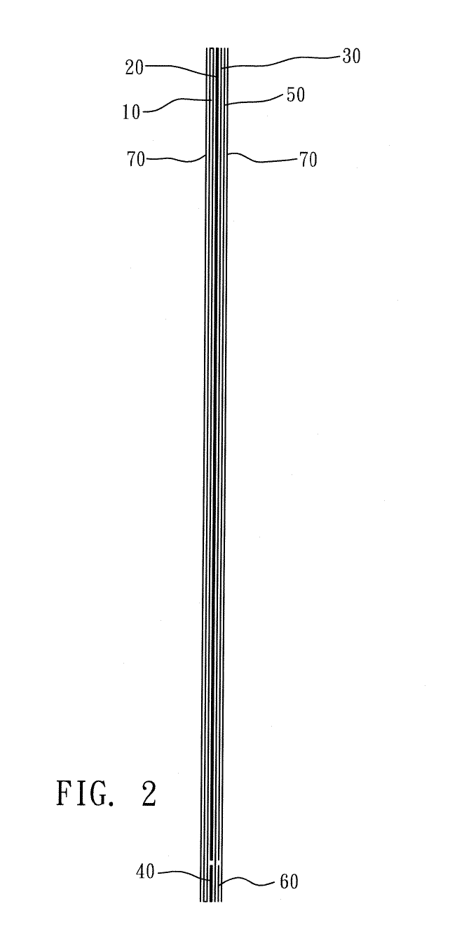

Moreover, the touch panel of the present invention is further disposed with a layer of anti-scratch optical coating 70 on one side of the second conductive layer 50, as shown in FIG. 1. The anti-scratch optical coating 70 can be made with anti-reflective or anti-glare material, wherein the anti-reflective or anti-glare material is a composite of, for example but not limited to, silicon dioxide (SiO₂), tin dioxide (TiO₂), or titanium dioxide (TiO₂). The anti-scratch optical coating 70 may also be disposed on the other side of the transparent substrate 10, as shown in FIG. 2, depending on actual demands.

The touch panel of the present panel is formed by directly coating the first conductive layer 20, the insulated dielectric layer 30, and the second conductive layer 50 on the transparent substrate 10. Since only one layer of the transparent substrate 10 is used, the light transmittance can be enhanced and the production cost can be reduced.

Further, in the touch panel of the present panel, since only one insulated dielectric layer 30 is present between the first conductive layer 20 and the second conductive layer 50, the spacing is reduced and thus the sensitivity is enhanced. Consequently, the structure of the touch panel of the present invention is indeed superior to conventional art.

Consequently, with the implementation of the touch panel of the present invention, the first conductive layer, the insulated dielectric layer, and the second conductive layer are directly coated on the transparent substrate to achieve the following advantages: enhanced light transmittance, reduced production cost, and increased sensitivity. Therefore, the drawbacks of the conventional art can be overcome.

The present invention provides a feasible solution, and a patent application is duly filed accordingly. However, it is to be noted that the preferred embodiments disclosed in the specification and the accompanying drawings are not intended to limit the invention. To the contrary, it is intended to cover various modifications and similar arrangements and procedures, and thus the scope of the appended claims should be accorded the broadest interpretation so as to encompass all such modifications and similar arrangements and procedures.

What is claimed is:

1. A touch panel structure, comprising at least:
a transparent substrate to carry the components described later;
a first conductive layer formed on one side of the transparent substrate and having a plurality of first sensing bands each of which is disposed with at least a first sensing zone and is disposed with a conductive wire on its end to connect with a first electrode layer;
an insulated dielectric layer formed on the first conductive layer; and
a second conductive layer coated on the insulated dielectric layer and having a plurality of second sensing bands each of which is disposed with at least a second sensing zone and is disposed with a conductive wire on its end to connect with a second electrode layer.

2. The touch panel structure as claimed in claim 1. wherein the transparent substrate may be made of glass, polycarbonate (PC), poly-methyl meth-acrylic (PMMA), polyethylene terephthalate (PET) and cellulose triacetate (TCA).

3. The touch panel structure as claimed in claim 1, wherein the first sensing bands and the second sensing bands are arranged in an orthogonal manner.

4. The touch panel structure as claimed in claim 1, wherein the first sensing bands are formed by coating on or etching the first conductive layer and arranged in parallel longitudinally to sense the pushing action along the X-direction and the first sensing zone of the sensing band is rhombic, bar-like, triangular, hexagonal, or circular in shape.

5. The touch panel structure as claimed in claim 1, wherein the first conductive layer and the second conductive layer are formed on the transparent substrate by coating.

6. The touch panel structure as claimed in claim 1, wherein the second sensing bands are formed by coating on or etching the second conductive layer and arranged in parallel longitudinally to sense the pushing action along the Y-direction and the second sensing zone of the sensing band is rhombic, bar-like, triangular, hexagonal, or circular in shape.

7. The touch panel structure as claimed in claim 1, wherein the first conductive layer and the second conductive layer may be formed by coating indium tin oxide (ITO), antimony-doped tin oxide (ATO) or other conductive materials.

8. The touch panel structure as claimed in claim 1, wherein the insulated dielectric layer may be formed by coating insulated materials.

9. The touch panel structure as claimed in claim 8, wherein the insulated material may be a composite of silicon dioxide (SiO2), tin dioxide (TiO2), or titanium dioxide (TiO2).

10. The touch panel structure as claimed in claim 1, wherein the other side of the second conductive layer is further disposed with an anti-scratch optical coating.

11. The touch panel structure as claimed in claim 10, wherein the anti-scratch optical coating may be made of anti-reflective or anti-glare material.

12. The touch panel structure as claimed in claim 11, wherein the anti-reflective or anti-glare material may be a composite of silicon dioxide (SiO2), tin dioxide (TiO2), or titanium dioxide (TiO2).

13. The touch panel structure as claimed in claim 1, wherein the other side of the transparent substrate is further disposed with an anti-scratch optical coating.

14. The touch panel structure as claimed in claim 13, wherein the anti-scratch optical coating may be made of anti-reflective or anti-glare material.

15. The touch panel structure as claimed in claim 14, wherein the anti-reflective or anti-glare material may be a composite of silicon dioxide (SiO2), tin dioxide (TiO2), or titanium dioxide (TiO2).

16. The touch panel structure as claimed in claim 1, wherein the first electrode layer and the second electrode layer may be formed by coating conductive paste on the transparent substrate.

17. The touch panel structure as claimed in claim 16, wherein the conductive paste may be silver paste, carbon paste, copper paste, or other conductive materials.
